(19) United States
(12) Patent Application Publication
(10) Pub. No.: US 2009/0193507 A1
(43) Pub. Date: Jul. 30, 2009

(54) AUTHENTICATION MESSAGING SERVICE

(76) Inventor: Wael Ibrahim, Cypress, TX (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 12/021,021

(22) Filed: Jan. 28, 2008

(51) Int. Cl. H04L 9/32

(52) U.S. Cl. 726/9

(57) ABSTRACT

In one embodiment an authentication server comprises one or more processors, and a memory module communicatively connected to the one or more processors. The memory module and comprises logic instructions which, when executed on the one or more processors configure the one or more processors to regulate access to a service in a communication network by performing operations, comprising receiving, in the authentication server, a first authentication token request for an authentication token, wherein the first authentication token request uniquely identifies a client computing device and a unique service, processing, in the authentication server, the first authentication token request, and transmitting an authentication token from the authentication token server to the client computing device when the first authentication token request is approved by the authentication server.

### BACKGROUND

Modern computing and communication capabilities have created an environment in which users of computer services access resources (e.g., data, applications, etc.) from different local and remote locations. By way of example, and not by limitation, laptop computers and personal digital assistants (PDAs) are commonly used at one or more locations at work in an office setting, and may be taken home or to other locations.

When users access services from remote locations, there exists a need for authentication of these remote devices to assure access may be granted to the requested services. In some circumstances it may be useful to enable remote device to be used as an authentication token in conjunction with an Authentication Token Service (ATS). ATS is not to authenticate the device, but is a technique to allow the use of a mobile device to authorize a service.

### BRIEF DESCRIPTION OF THE DRAWINGS

FIG. 1 is a schematic illustration of an authentication token server network computing environment in which an authentication service may be implemented, according to embodiments.

FIG. 2 is a schematic illustration of an authentication token server adapted to incorporate an authentication service, according to embodiments.

FIG. 3 is a flowchart illustrating operations implementing an authentication token server, according to embodiments.

FIG. 4A is a flowchart illustrating operations implementing an authentication service, according to embodiments.

FIG. 4B is a flowchart illustrating operations implementing an authentication service, according to embodiments.

FIG. 5 is a schematic illustration of one embodiment in which an authentication service may be implemented.

FIG. 6 is a schematic illustration of one embodiment in which an authentication service may be implemented.

FIG. 7 is a schematic illustration of one embodiment in which an authentication service may be implemented.

FIG. 8 is a schematic illustration of one embodiment in which an authentication service may be implemented.

FIG. 9 is a schematic illustration of one embodiment in which an authentication service may be implemented.

FIG. 10 is a schematic illustration of one embodiment in which an authentication service may be implemented.

### DETAILED DESCRIPTION

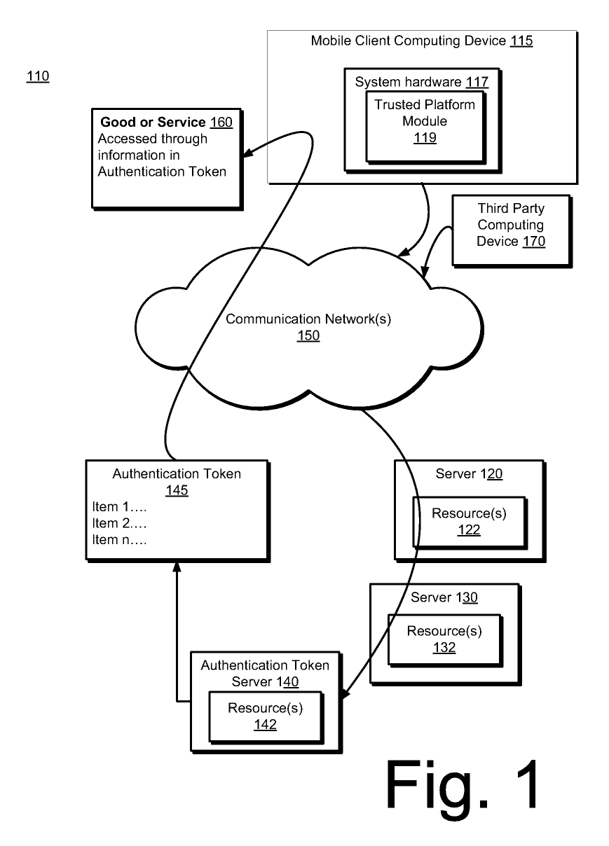

FIG. 1 is a schematic illustration of one embodiment of a networked computing environment 110 in which an authentication token service (ATS) may be implemented. In some embodiments, an ATS is an extension of a Short Message Service (SMS) with guaranteed delivery and return code status. The networked computing environment 110 is intended to illustrate a client-server network configuration, and may represent a computing environment that spans a corporate or college campus, a city, or an entire geographic region.

Computing environment 110 comprises a number of resource servers 120, 130, 140 communicatively coupled by at least one communication network 150. In some embodiments, at least one of the servers is used at least partially as an authentication token server 140. In the embodiment depicted in FIG. 1, servers 120, 130, 140 comprise respective resources 122, 132, 142, such as, e.g., applications, storage, or other resources. Servers 120, 130, 140 need not be centrally located. Servers 120, 130, 140 may be physically remote from one another and maintained separately. In some embodiments, the authentication token server 140, may be the first server to receive an authentication token request from the client computing device 115. In some embodiments, the authentication token server 140 may receive the authentication token request via one or more intermediary servers 120, 130.

Servers 120, 130 are communicatively connected to a communication network 150. In some embodiments, the authentication token server 140 may be communicatively connected to the communication network 150, either through one or more servers 120, 130 or directly. The server connection may be implemented as a Personal Area Network (PAN), Local Area Network (LAN), Metropolitan Area Network (MAN) or a Wide Area Network (WAN) or the like. Furthermore, communication network 150 may comprise one or more sub-networks. By way of example, and not by limitation, communication network 150 may comprise one or more wireless access points (WAPs) that establish a wireless network, which is coupled to a LAN or directly to a backbone network such as the Internet. Additionally, the communication network 150 may include a variety of input/output transports such as, but not limited to; wired USB or serial links, Wireless 802.11x link, wireless USB, Blue-tooth, infra red link or the like.

At least one mobile client computing device(s) 115 may communication with servers 120, 130, 140 via a communication network 150. In some embodiments, an authentication token request may originate from a client computing device 115 or from a third party computing device 170. Each client computing device 115 in the computing environment 110 may be implemented as a fully functional client computer or as a thin client computing device. The number of clients may be related to the computing power of the servers 120, 130, 140. If the servers have a high degree of computing power (for example, fast processor(s) and/or a large amount of system memory) then they will be able to effectively serve a relatively large number of client computers. By way of example and not limitation, a mobile client computing device 115 may be a mobile phone, smart phone, laptop or the like.

In some embodiments, system hardware 117 may further include a trusted platform module (TPM) 119, which may be used to establish a trusted computing relationship between a mobile client computing device 115 and at least one other computer system. In some embodiments, TPM 119 may be embodied as an application specific integrated circuit (ASIC). Alternatively, TPM 119 may be embodied as logic instructions encoded in a programmable controller, e.g., a field programmable gate array (FPGA) or as logic instructions stored in a computer-readable medium and executable on a general purpose processor, e.g., software. TPM 119 may include non-volatile random access memory (NVRAM), which may be used, e.g., to store certificates, among other things.

In some embodiments, access information for the client computing system 115 may be stored in a platform configuration register (PCR) or other non volatile memory in the TPM. The PCR is a register in the TPM that contains values representative of the platform configuration and state. The PCR may be used to store result(s) of a chain of message digests representing various platform configurations such as BIOS, boot block, etc. By way of example, and not by limitation, a location parameter may be extended to one of the PCRs, which would be part of the integrity metrics of the platform.

In some embodiments, the mobile client computing device 115 may be capable of utilizes X.509 digital certificates. This would allow the client computing device to include a structured set of uniquely identifying elements along with an authentication token request. Generally, a X.509 digital certificate includes the following elements; Version, Serial number, Algorithm ID, Issuer, Validity not before, Validity not after, Subject, Subject public key information, and the like.

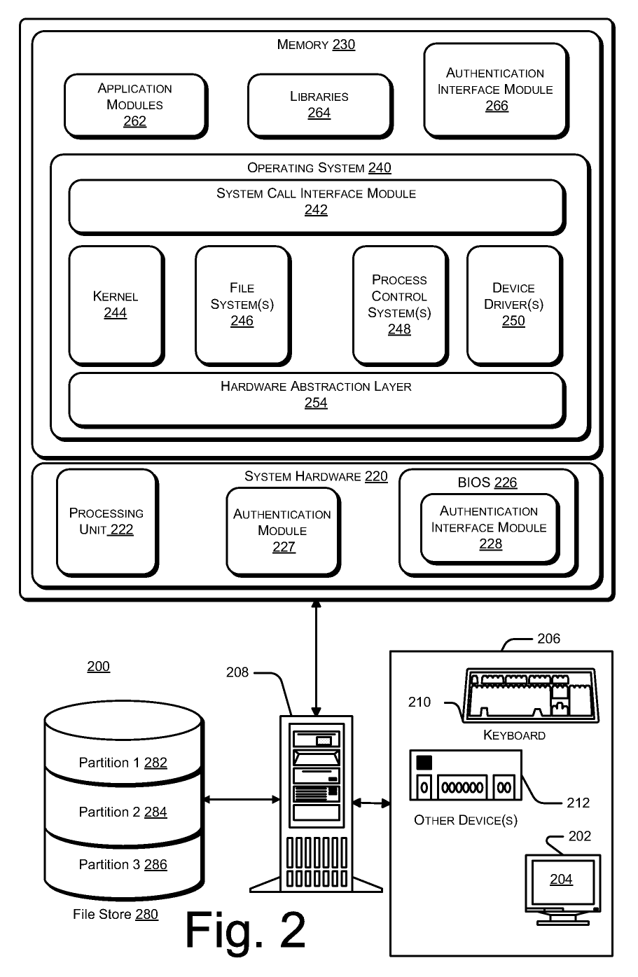

FIG. 2 is a schematic illustration of an authentication token server 200 adapted to include an authentication token service (ATS), according to embodiments. The authentication token sever 200 includes a computing engine 208 and possibly one or more accompanying input/output devices 206 including, but not limited to, a display 202 having a screen 204, a keyboard 210, and other I/O device(s) 212. The other device(s) 212 may, by way of example, and not by limitation, include a touch screen, a voice-activated input device, a track ball, a mouse and any other device that allows the sever 200 to receive input from a developer and/or a user.

The computing engine 208 includes system hardware 220 commonly implemented on a motherboard and at least one auxiliary circuit board. System hardware 220 includes a processor 222 and a basic input/output system (BIOS) 226. BIOS 226 may be implemented in flash memory and may comprise logic operations to boot the computer device and a power-on self-test (POST) module for performing system initialization and tests. In operation, when activation of authentication token server 200 begins processor 222 accesses BIOS 226 and shadows the instructions of BIOS 226, such as power-on self-test module, into operating memory. Processor 222 then executes power-on self-test operations to implement POST processing.

Authentication token server 200 further includes a file store 280 communicatively connected to computing engine 208. File store 280 may be internal such as, e.g., one or more hard drives, or external such as, e.g., one or more external hard drives, network attached storage, or a separate storage network. In some embodiments, the file store 280 may include one or more partitions 282, 284, 286.

Memory 230 includes an operating system 240 for managing operations of computing engine 208. In one embodiment, operating system 240 includes a hardware abstraction layer 254 that provides an interface to system hardware 220. In addition, operating system 240 includes a kernel 244, one or more file systems 246 that manage files used in the operation of computing engine 208 and a process control subsystem 248 that manages processes executing on computing engine 208. Operating system 240 further includes one or more device drivers 250 and a system call interface module 242 that provides an interface between the operating system 240 and one or more application modules 262 and/or libraries 264. The various device drivers 250 interface with and generally control the hardware installed in the computing system 200.

In operation, one or more application modules 262 and/or libraries 264 executing on computing engine 208 make calls to the system call interface module 242 to execute one or more commands on the computer's processor. The system call interface module 242 invokes the services of the file systems 246 to manage the files required by the command(s) and the process control subsystem 248 to manage the process required by the command(s). The file system(s) 246 and the process control subsystem(s) 248, in turn, invoke the services of the hardware abstraction layer 254 to interface with the system hardware 220. The operating system kernel 244 can be generally considered as one or more software modules that are responsible for performing many operating system functions.

The particular embodiment of operating system 240 is not critical to the subject matter described herein. Operating system 240 may, for example, be embodied as a UNIX operating system or any derivative thereof (e.g., Linux, Solaris, etc.) or as a Windows® brand operating system or another operating system.

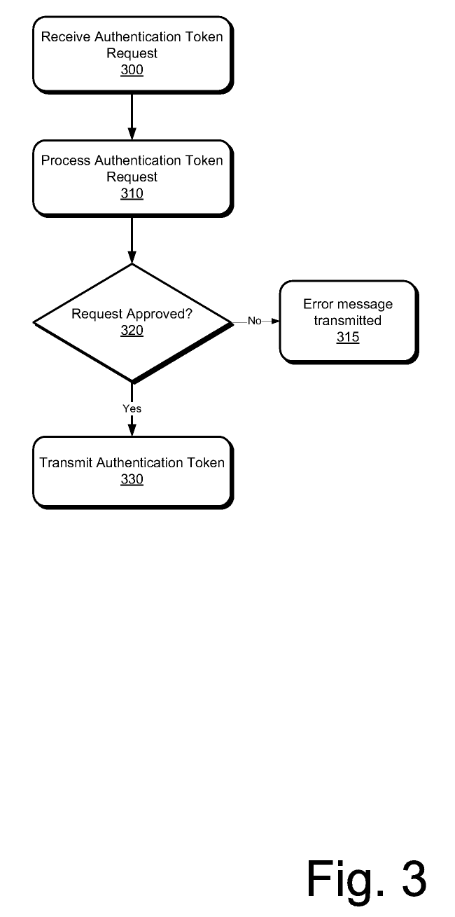

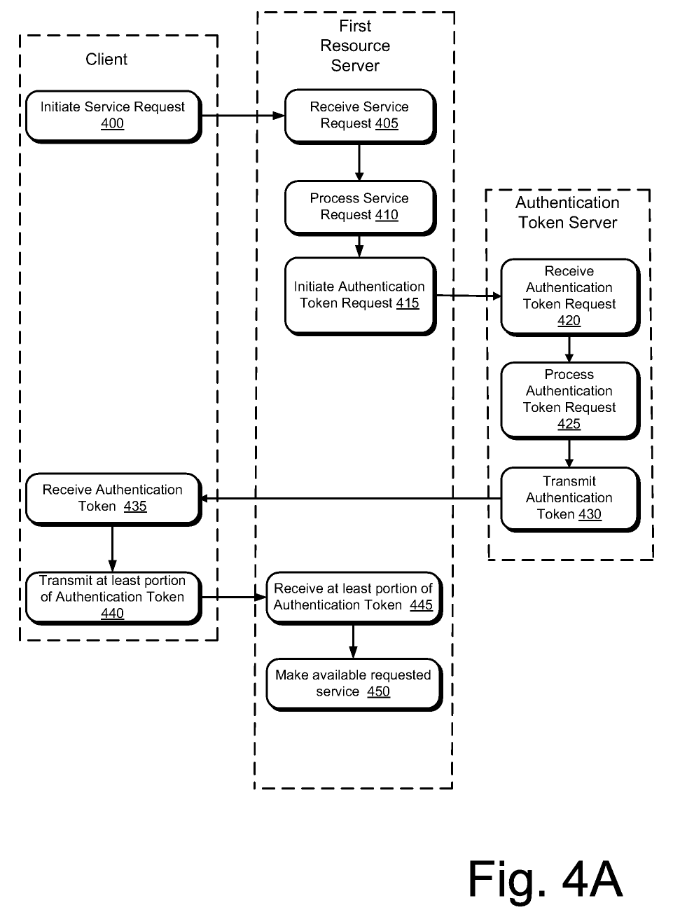

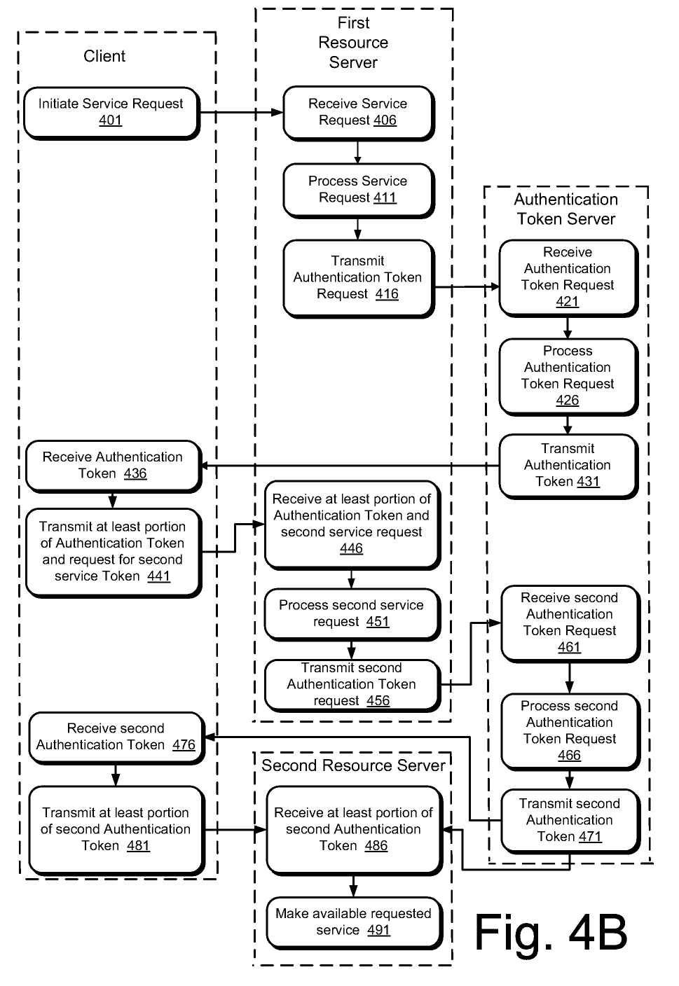

In some embodiments, authentication token server 200 includes at least one authentication module 227, which may comprise operational logic and may include or invoke hardware that can communicate with at least one remote device. In the embodiment depicted in FIG. 2, BIOS 226 includes an authentication interface module 228 and system memory 230 includes a authentication interface module 266. Operations implemented by the authentication interface modules 228, 266 will be discussed in greater detail below, with reference to FIGS. 3 and 4.

In operation, the mobile client computing device 115 may request an authentication token to gain access to a good or service 160. In some embodiments, the authentication token request may take the form of, but not limited to; client interaction with an automated phone service, Short Messaging Service (SMS) message, Enhanced Messaging Service (EMS) messages, Multimedia Messaging Service (MMS) messages or the like. In some embodiments, information that uniquely identifies the mobile client computing device 115 is included with an authentication token request. By way of example, and not by limitation, the uniquely identifying information may take the form of; a caller ID, subscriber identity module (SIM) card ID, TPM metrics, X.509 certificates, a PIN on the phone that can be assigned and sent separately in a SMS message, a biometric scan, or the like. The uniquely identifying information included with the authentication token request may depend of the level of security or convenience the service provider wishes to provide. Additionally, in some embodiments, the authentication token may be applied in conjunction with other security elements present in the client's computing device, such as but not limited to; SIM cards, Smart Cards, USB dongles or the like. Furthermore, the authentication token request communication may use encryption protocols, such as, but not limited to, RSA encryption, or the like.

Once the authentication token server 140 has received a request from the mobile client computing device 115, the authentication token server 140 verifies that the client may obtain the requested good or service 160. In some embodiments, this verification is performed by using the uniquely identifying information accompanying the request to assure the identity of mobile the client computing device 115.

By way of example, and not by limitation, a client may have forgotten an access password. The client may make an authentication token request to obtain a new or temporary password through the help line of an IT department. The request is processed through an authentication token server which matches the mobile client computing device's uniquely identifying information with the client making the request, and then determines if the request may be granted. If the client may access the requested service, then an authentication token form 145 is sent to the mobile client computing device 115. The authentication token form 145 may include information such as a certificate granting access to a certain service or good 160, accompanied by a temporary PIN number to gain access to the service or good 160. In some embodiments, an additional step of verification may be required before the client may gain access to the service or good 160. By way of example, and not by limitation, the client may be asked to; enter a PIN number into the mobile client computing device 115, verbally confirm access has been requested and accepted, access the authentication token in a limited location or time, or the like. Furthermore, in some embodiments, the authentication token 145 may be used as additional uniquely identifying information that a client may then use to gain access to additional goods or services 160 by coupling the authentication token 145 with another authentication token request.

FIG. 3 is a flowchart illustrating operations implementing an authentication token server, according to embodiments. Referring to FIG. 3, at operation 300, an authentication token server receives a request. In some embodiments, this request may be from a mobile client computing device 115. In some embodiments, there may be multiple resource servers in a chain that receive an authentication token request before the authentication token server receives the request. In some embodiments, the authentication token server and other servers are physically separate servers. In some embodiments, the authentication token server and other servers reside in the same computer system.

At operation 310, the authentication token request is processed. If, at operation 320, the client may not access the requested service, then an error message is sent 315 to a client computing device. In some embodiments, the authentication token server may use uniquely identifying information of the client computing device to determine if the client may access the requested service. By contrast, if at operation 320, the client may access the requested service, the authentication token server then transmits an authentication token at operation 330. In some embodiments, the requesting client computing device is the device to which the authentication token form is sent. In some embodiments, the requesting client computing device may be a third party device and the authentication token form is sent to a different client computing device.

FIG. 4A is a flowchart illustrating operations in one embodiment of implementing an Authentication Token Service (ATS). In some embodiments, a client may use the ATS during the boot operations of a client computing device. By way of example, and not by limitation, if a client computing device requires a password to fully boot, a service request may be initiated if the client has forgotten the password. In some embodiments, a client may use the ATS as an application on a client computing device. By way of example, and not by limitation, a client may initiate an authentication token request to obtain a password to another computing device.

Referring to FIG. 4A, at operation 400 a client makes a service request to a first resource server. In some embodiments, this could occur when a client is shopping and selects items from a virtual or real store window he or she wishes to purchase. At operation 405, a first resource server receive a service request. The service request is processed at operation 410 and an authentication token request is initiated at operation 415 and relayed to an authentication token server. In some embodiments, the resource server may be an electronic store front or the like.

At operation 420, an authentication token server receives an authentication token request. The authentication token server processes the authentication token request at operation 425, and transmits an authentication token at operation 430. In some embodiments, an authentication token sever may be communicatively connected to a client's bank, may receive a request for funds for a specified good or service, and may transmit to the client a code to access the requested good or service after releasing the required funds to the vendor.

At operation 435, a client computing device receives an authentication token and may transmit at least a portion of the authentication token at operation 440 to a first resource server to gain access to requested goods or services. At operation 445, a first resource server receives at least a portion of the authentication token from a client and may grant access to requested goods or services 450. In some embodiments, a client may receive an authentication token, present at least a portion of that token at a store, and be granted access to the requested goods or services.

FIG. 4B is a flowchart illustrating operations in one embodiment of implementing an Authentication Token Service (ATS). In some embodiments, an authentication token service may use multiple authentication tokens for reasons such as, but not limited to, additional security, additional feature access, or the like.

Referring to FIG. 4B, at operation 401 a client makes a service request to a first resource server. At operation 406, a first resource server receive a service request, the service request is processed at operation 411 and an authentication token request is initiated at operation 416 and relayed to an authentication token server. At operation 421, an authentication token server receives an authentication token request. The authentication token server processes the authentication token request at operation 426, and transmits an authentication token at operation 431.

At operation 436, a client may receive an authentication token from an authentication token server. At operation 441, a client may transmit at least a portion of the authentication token and a second service request to a first resource server. In some embodiments, a client may wish to gain access to additional features or services, such a much not limited to, a list of recent purchases, a voting history or the like. At operation 446, a first resource server receives at least a portion of the authentication token from a client and a second service request, processes the request at operation 451, and transmits a second authentication token request at operation 456 to an authentication token server.

At operation 461, an authentication token server receives a second authentication token request. At operation 466, an authentication token server processes a second authentication token request. In some embodiments, the authentication token server may receive a second request and couple it with information from a client's first request to allow additional access to goods or services. At operation 471, an authentication token service transmits an authentication token to both a second resource server and a client. At operation 476, a client may receive a second authentication token, and may transmit at least a portion of the second authentication token to a second resource server 481. At operation 486, a second resource server may receive at least portions of a second authentication token from a client and from an authentication token server. In some embodiments, a client may send a portion of a second authentication token to a second resource server, such as much not limited to, a server which contains history information in regards to a client's prior purchases. At operation 491, a second resource server makes the secondarily requested goods or services available. In some embodiments, this may include, but is not limited to, additional features for a purchased item, a history or purchases, a voting record, or the like.

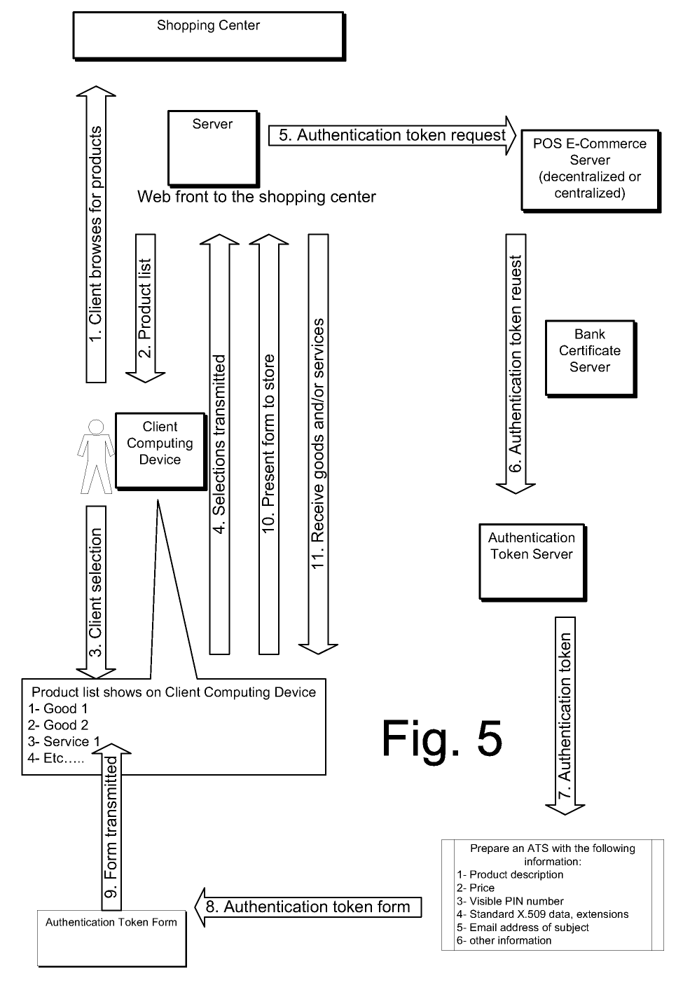

FIGS. 5 through 10 are schematic illustrations of various embodiments of an authentication token service (ATS). The embodiments shown in FIGS. 5 through 10 are examples, and are not intended to suggest any limitation as to the scope of the functionality of the invention; the invention is not necessarily dependent on the features shown in FIGS. 5 through 10.

FIG. 5 represents an embodiment of the authentication token service (ATS) in the context of shopping for goods. The operations described herein are not meant as limitations on the invention. Referring to FIG. 5, Firstly, a shopper may browse for products. This browsing may occur in many ways, such as but not limited to, going to a shopping mall, browsing the web or the like. Secondly, a list of products may be created from the shoppers browsing. This list is communicated to the shopper's computing device. Thirdly, the shopper may select among the listed items as to which ones to purchase. Fourthly, the shopper's purchase requests may be communicated to a server. The purchase request may be accompanied by uniquely identifying information linked to the shopper's computing device. With reference to FIG. 5, the server may be a web front to the shopping center, a web page, or the like. Fifthly, an authentication token request is made to an E-commerce server or the like. Sixthly, the authentication token request may be sent to a bank server, such as the shopper's bank server, in order to authorize the transaction and release the requested funds. Seventhly, if the request is authorized, an authentication token server generates an authentication token. This token may include, but is not limited to, information such as; a purchase description, the price, a visible PIN number, standard X.509 data, an email address of the subject or the like. Eighthly, an authentication token form is generated. The form may differ depending on the variety of computing device the shopper may be using. Ninthly, the authentication token form is send to the shopper's computing device. Tenthly, the shopper may then present the purchase request to the retailer with the accompanying authentication token and in some cases other forms of identity verification, such as a PIN. Finally, the shopper may receive a receipt of the transaction. This receipt may be sent to the shopper's computing device, a separate email address or the like.

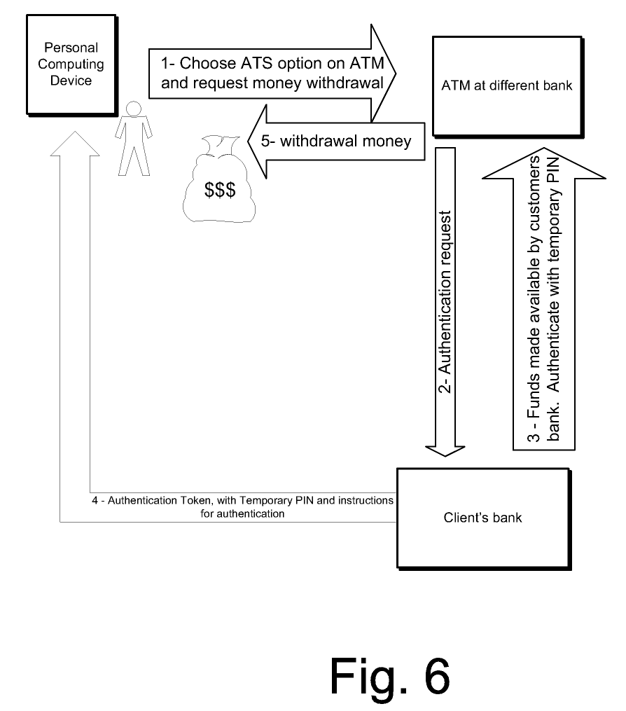

FIG. 6 represents an embodiment of the authentication token service (ATS) in the context of obtaining money from a bank when the customer does not have access to a bank card. The operations described herein are not meant as limitations on the invention. Referring to FIG. 6, firstly, a user makes a withdrawal request at an automated teller machine (ATM), choosing the ATS option. This may be necessary in circumstances such as, but not limited to, when a user loses his or her ATM card. Secondly, the ATS cash withdrawal request is transmitted to a bank at which the customer has an account. Thirdly, the customer's bank approves the request for cash withdrawal and sends the approval along with a required temporary PIN to the first bank. Fourthly, the customer's bank sends an authentication token form to the customer's computing device. This token may include, but is not limited to, information such as, a temporary PIN, and instructions for authentication. Finally, the customer may use the temporary PIN received through the authentication token form to access funds at the ATM.

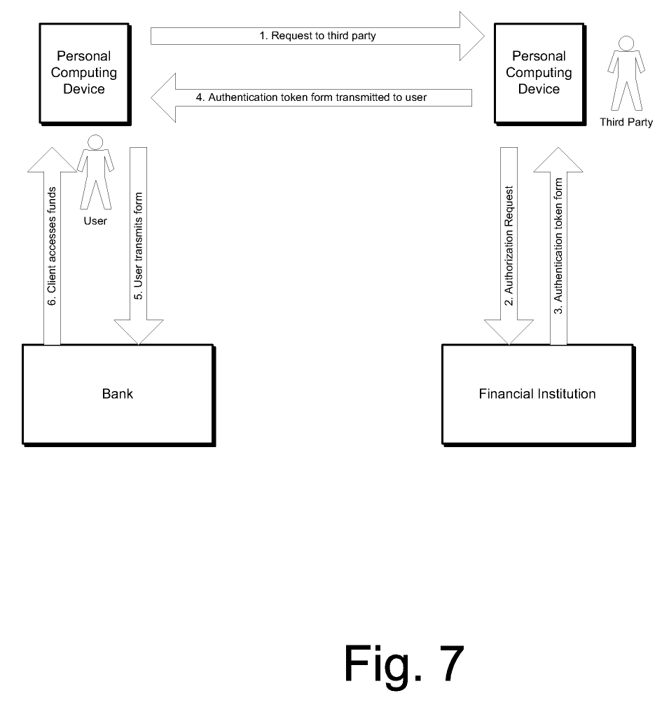

FIG. 7 represents an embodiment of the authentication token service (ATS) in the context of obtaining money from another source, such as a friend, third party or the like. The operations described herein are not meant as limitations on the invention. Referring to FIG. 7, firstly, a user may contact a third party to inform the third party that the user is in need of money. Secondly, the third party may make an authentication token request to a financial institution. Thirdly, the financial institution may grant the third party's request and send an authentication token form to the third party to allow access to funds. Fourthly, the third party may contact the initial user whom was in need of money, and relay the authentication token form to the user. Fifthly, the user may then transmit the authentication token at a bank to gain access to the requested funds. Sixthly, the bank may approve the authentication token and grants access to the requested funds. In transactions such as these, additional forms of identity verification may be included in the authentication token form, such as but not limited to, a voice command authorizing the release of funds, or the like.

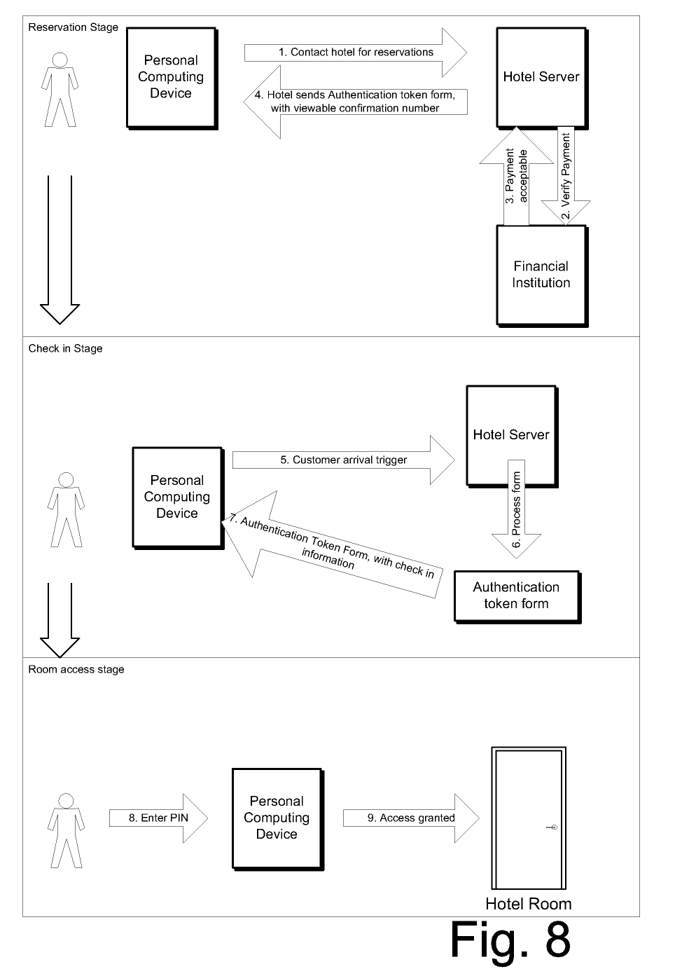

FIG. 8 represents an embodiment of the authentication token service (ATS) in the context of reservations, check-in, and access to a room at a hotel. The operations described herein are not meant as limitations on the invention. Referring to FIG. 8, firstly, a customer may use a computing device to contact a hotel for reservations. This may be done over a variety of interfaces, such as but not limited to, an automated reservation phone service, the internet, or the like. Secondly, the hotel server may send an authentication token request to a financial institution to confirm the customer has sufficient funds, the method of payment, and the like. Thirdly, the financial institution may send the required funds along with an authentication token form to the hotel server. Fourthly, the hotel may provide the customer with an authentication token form with information such as but not limited to; a hotel room purchase conformation number, a viewable conformation number for the user to use during check in and the like. Fifthly, the customer may arrive at the hotel and the room purchase confirmation is communicated to an automated check in service at the hotel. In some embodiments, the confirmation communication may be triggered by the customer's proximity to the hotel. Sixthly, the hotel server may prepare an authentication token form including information such as but not limited to; the room number, a map of how to get to the room, a visible PIN to open the door, a garage PIN or the like. Seventhly, the authentication token form is send to the customer's computing device. Eighthly, when the customer is near the room, the customer may enter the door PIN into his or her computing device. Finally, the room door may open in response to communication of the PIN from the customer's computing device.

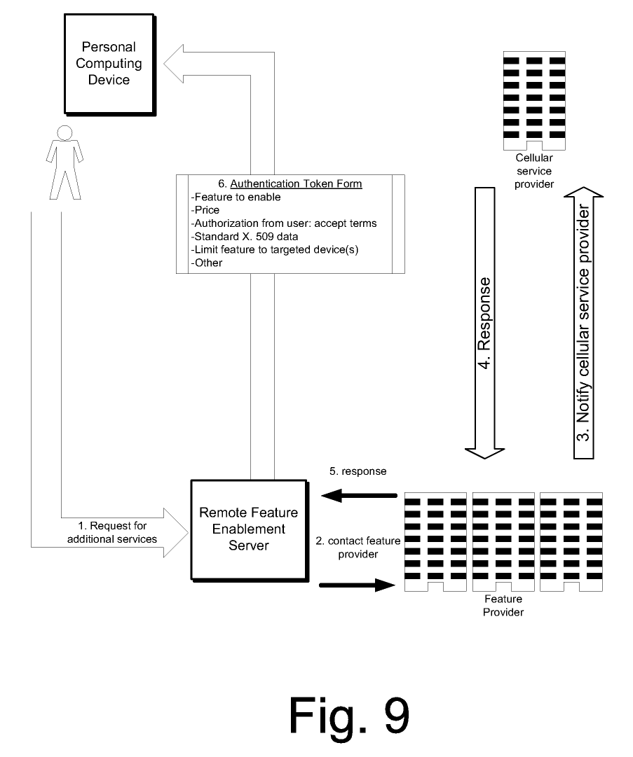

FIG. 9 represents an embodiment of the authentication token service (ATS) in the context of activation of additional or difference feature for a user's computing device. The operations described herein are not meant as limitations on the invention. Referring to FIG. 9, firstly, a user may request additional or different features for his or her computing device. This request may be communicated a to remote feature enablement server. Secondly, the remote feature enablement server may contact the feature provider to determine if the user may access the additional features. Thirdly, the feature provider may notify the cellular service provider of the change to the user's feature services. Fourthly, the cellular service provider may respond to the feature provider. The response may include items such as, but not limited to; information to relay to the user, permission to offer the feature, confirmation of notification or the like. Fifthly, the feature provider may communicate with the remote feature enablement server. Sixthly, the remote feature enablement server may communicate an authentication token form to the user. In some embodiments, the form may include information such as, but not limited to; a description of the enabled feature, the price, terms of acceptance, limitation of the feature to a targeted device or the like.

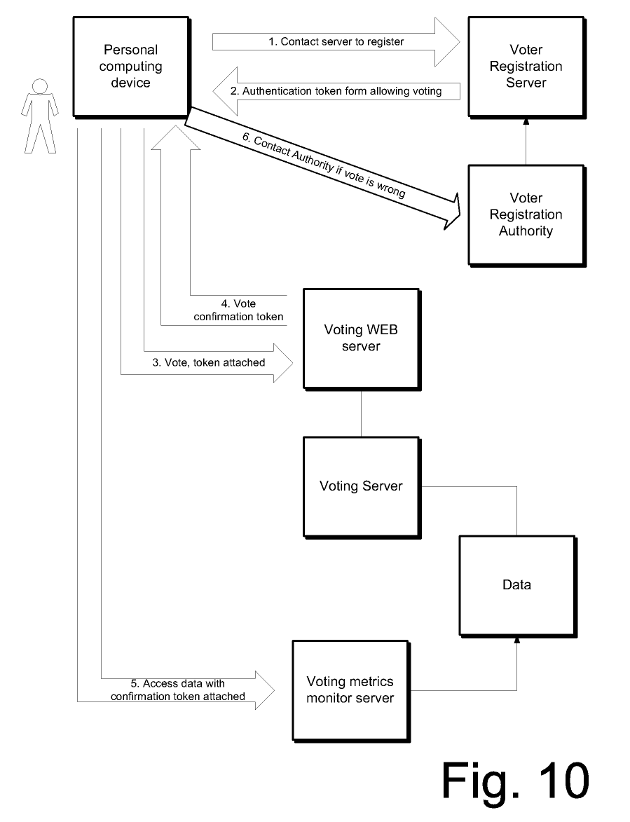

FIG. 10 represents an embodiment of the authentication token service (ATS) in the context of voting. The operations described herein are not meant as limitations on the invention. Referring to FIG. 10, firstly, a voter may contact the voter registration server and request registration and authorization to vote. The voter registration server may confirm with the voter registration authority that the voter has the right to vote. Secondly, the voter registration server may send an authentication token form to the voter. In some embodiments, the authentication token form may be used once as to assure the voter may only cast one vote. The authentication token form may have additional identity security features, such as but not limited to; a voice confirmation, a finger print, or the like. Thirdly, the voter may send a message to the voting server and may cast votes for the voter's chosen candidates. The message is accompanied by the authentication token form received from the voter registration server. Fourthly, the voting server may send a response to the voter both confirming the voter's vote and providing an authentication token form to allow the voter access to additional services. Fifthly, the voter may use the confirmation authentication token form as access to additional services such as but not limited to, viewing the voter's voting record or the like. Sixthly, if the voter finds a point of concern, such as a vote registered for a candidate for whom the voter did not intent to vote then the voter may contact the voting authorities to correct the error.

Thus, described herein are exemplary system and methods for implementing authentication token services in computer network systems. The methods described herein may be embodied as logic instructions on a computer-readable medium. When executed on a processor, the logic instructions cause a general purpose computing device to be programmed as a special-purpose machine that implements the described methods. The processor, when configured by the logic instructions to execute the methods recited herein, constitutes structure for performing the described methods.

Reference in the specification to “one embodiment” or “an embodiment” means that a particular feature, structure, or characteristic described in connection with the embodiment is included in at least an implementation. The appearances of the phrase “in one embodiment” in various places in the specification are not necessarily all referring to the same embodiment.

What is claimed is:

1. A method to regulate access to a service in a communication network accessible by one or more mobile devices, comprising:
receiving, in an authentication server, a first authentication token request for an authentication token, wherein the first authentication token request uniquely identifies a mobile client computing device and a unique service;
processing, in the authentication server, the first authentication token request; and
transmitting an authentication token from the authentication server to the mobile client computing device when the first authentication token request is approved by the authentication server.

2. The method of claim 1, wherein:
the first authentication token request is initiated by a service request to a first resource server coupled to a communication network; and
the first resource server transmits the authentication token request to the authentication server.

3. The method of claim 1, wherein the client computing device transmits the first authentication token request directly to the authentication server.

4. The method of claim 1, wherein:
the first authentication token request is transmitted to the authentication token server via a first communication channel; and
the authentication token is transmitted from the authentication token server to the mobile client computing device via a second communication channel, different from the first communication channel.

5. The method of claim 2, wherein the authentication token comprises a code which a user of the mobile client computing device must provide to the first resource server in order to access the resource provided by the first resource server.

6. The method of claim 1, wherein processing the first authentication token request comprises:
validating at least one of the mobile client computing device and the user; and
assigning an initiation time and an expiration time to the authentication token.

7. The method of claim 2, further comprising:
receiving the authentication token in the mobile client computing device; and
transmitting at least a portion of the authentication token from the mobile client computing device to the first resource server to complete the service request.

8. The method of claim 2, wherein:
the first authentication token request comprises encryption data generated at least in part based on at least one specific hardware parameter of the mobile client computing device; and
the authentication server transmits a key component to the first resource server.

9. The method of claim 8, further comprising:
receiving the service request and at least a portion of the authentication token in the first resource server;
decrypting the service request
generating, in the first resource server, a second service request for a second authentication token, wherein the second authentication token request uniquely identifies the mobile client computing device, the first resource server, a second resource server, and a unique service; and
transmitting the second authentication token to the authentication server.

10. The method of claim 9, further comprising:
receiving, in the authentication server, the second authentication token request; and
processing the second authentication token request, wherein processing the second authentication token request comprises:
confirming, in the authentication server, a successful completion of the first service request; and
validating at least one of the mobile client computing device and the user; and
assigning an initiation time and an expiration time to the authentication token for the second service request; and
transmitting the authentication token for the second service request to the client computing device.

11. The method of claim 10, wherein:
the second authentication token request comprises encryption data generated at least in part based on at least one specific hardware parameter of the client computing device and at least one specific hardware parameter of the first resource server; and
the authentication server transmits a key component to the second resource server.

12. The method of claim 10, further comprising:
receiving, in the mobile client computing device, the authentication token for the second service request; and
transmitting at least a portion of the authentication token for the second service request from the mobile client computing device to the second resource server to complete the service request.

13. An authentication server, comprising:
one or more processors;
a memory module communicatively connected to the one or more processors and comprising logic instructions which, when executed on the one or more processors configure the one or more processors to regulate access to a service in a communication network by performing operations, comprising:
receiving, in the authentication server, a first authentication token request for an authentication token, wherein the first authentication token request uniquely identifies a mobile client computing device and a unique service;
processing, in the authentication server, the first authentication token request; and
transmitting an authentication token from the authentication token server to the mobile client computing device when the first authentication token request is approved by the authentication server.

14. The authentication server of claim 13, further comprising a first resource server coupled to the authentication server via a communication network, wherein:
the first authentication token request is initiated by a service request to the first resource server coupled to the communication network; and
the first resource server transmits the authentication token request to the authentication server.

15. The authentication server of claim 13, wherein:
the first authentication token request is transmitted to the authentication token server via a first communication channel; and
the authentication token is transmitted from the authentication token server to the mobile client computing device via a second communication channel, different from the first communication channel.

16. The authentication server of claim 13, further comprising logic instructions which, when executed on the one or more processors configure the one or more processors to:
validate at least one of the mobile client computing device and the user; and
assign an initiation time and an expiration time to the authentication token.

17. The authentication server of claim 14, further comprising logic instructions which, when executed on the one or more processors configure the one or more processors to:
receive the authentication token in the mobile client computing device; and
transmit at least a portion of the authentication token from the client computing device to the first resource server to complete the service request.

18. The authentication server of claim 14, wherein:
the first authentication token request comprises encryption data generated at least in part based on at least one specific hardware parameter of the mobile client computing device; and
the authentication server transmits a key component to the first resource server.

19. The authentication server of claim 18, further comprising logic instructions which, when executed on the one or more processors configure the one or more processors to:
receive the service request and at least a portion of the authentication token in the first resource server;
decrypt the service request
generate, in the first resource server, a second authentication token request for an authentication token, wherein the second authentication token request uniquely identifies the mobile client computing device, the first resource server, a second resource server, and a unique service; and
transmit the second authentication token to the authentication server.

20. The authentication server of claim 19, further comprising logic instructions which, when executed on the one or more processors configure the one or more processors to:
receive, in the authentication server, the second authentication token request; and
process the second authentication token request, wherein processing the second authentication token request comprises:
confirming, in the authentication server, a successful completion of the first service request; and
validating at least one of the client computing device and the user; and
assigning an initiation time and an expiration time to the authentication token for the second service request; and
transmit the authentication token for the second service request to the client computing device.

21. The authentication server of claim 20, wherein:
the second authentication token request comprises encryption data generated at least in part based on at least one specific hardware parameter of the client computing device and at least one specific hardware parameter of the first resource server; and
the authentication server transmits a key component to the second resource server.

22. The authentication server of claim 20, further comprising logic instructions which, when executed on the one or more processors configure the one or more processors to:
receive, in the client computing device, the authentication token for the second service request; and
transmit at least a portion of the authentication token for the second service request from the mobile client computing device to the second resource server to complete the service request.
